(19) United States
(12) Patent Application Publication
(10) Pub. No.: US 2011/0042534 A1
(43) Pub. Date: Feb. 24, 2011

(54) DEVICE AND METHOD FOR ASSISTING REMOVAL AND/OR INSTALLATION OF TRUNNION ROLLER

(75) Inventor: Michael James Van Koeverden, Belmont North (AU)

Correspondence Address: SCHWEGMAN, LUNDBERG & WOESSNER, P.A., P.O. BOX 2938, MINNEAPOLIS, MN, 55402, US

(73) Assignee: GLENMARK PHARMACEUTICALS ,S.A., La Chaux-de-Fonds (CH)

(21) Appl. No.: 12/808,925

(22) PCT Filed: Dec. 19, 2008
(86) PCT No.: PCT/AU2008/001882

§ 371 Date: Oct. 25, 2010

(30) Foreign Application Priority Data
Dec. 19, 2007 (AU) 2007906970
Apr. 15, 2008 (AU) 2008901872

(51) Int. Cl. F16M 13/02; B23P 19/00; B23P 6/00

(52) U.S. Cl. 248/251; 29/700; 29/402.08

(57) ABSTRACT

A device and/or method for assisting the removal and/or installation of a trunnion roller, the device including: an elongate main body portion including an actuator at one end and an engagement means at the other end for engaging and retaining a trunnion roller; a pivot point disposed at a position along the elongate main body portion between the actuator and the engagement means, wherein operation of the actuator causes the engagement means to move about the pivot point.

The present invention relates to a device and method for assisting removal and/or installation of a trunnion bearing or roller used in heavy machinery.

### BACKGROUND OF THE INVENTION

Trunnion bearings or rollers (hereinafter referred to as “trunnion rollers”) that are present in heavy machinery configurations often weigh in excess of 25 kg each due to the large loads they are supporting whilst in use. Generally trunnion rollers are used to support large rotatable drums and the axis points for which are typically seated in a U-bracket in use allowing the main body of the roller to rotate. Once a trunnion roller fails during operation, it is necessary to cease operation of the heavy machinery and remove the failed trunnion roller and replace it with a working one. The replacement is typically achieved manually, placing a significant load on the person undertaking the removal and replacement of the trunnion roller, particularly in situations where it is awkward to gain access to the trunnion roller within the machinery configuration.

Mobile concrete agitator trucks are used in the manufacture and delivery of ready mixed concrete to construction sites around the world. The large mixing bowl used on these agitator trucks typically rests upon trunnion rollers. The trunnion rollers whilst supporting the weight of the bowl, allow the bowl to spin along its axis in one direction to mix the concrete and also allow the bowl to spin in the opposite direction to discharge the concrete.

As with many load bearing mechanical parts, the trunnion rollers used in mobile concrete agitator trucks fail after a period of time and often when the bowl is full of concrete at a building site for example. In such an event, the truck must return to a suitable site that has a crane in order to elevate the mixing bowl to a sufficient height for a person to remove the failed trunnion roller and replace with a new one. This usually results in any concrete present in the mixing bowl being wasted.

In light of the above, the present invention seeks to provide a device and/or method for use when replacing and/or installing trunnion rollers that does not subject a person replacing the trunnion roller to significant load strain.

In addition, the present invention seeks to provide a device and/or method for replacing and/or installing trunnion rollers on mobile concrete agitator trucks which does not require the need for a crane but which may be done at any location, thereby limiting any concrete wastage.

### SUMMARY OF THE INVENTION

According to one aspect the present invention provides a device for assisting the removal and/or installation of a trunnion roller, the device including:
an elongate main body portion including an actuator at one end and an engagement means at the other end for engaging and retaining a trunnion roller;
a pivot point disposed at a position along the elongate main body portion between the actuator and the engagement means, wherein operation of the actuator causes the engagement means to move about the pivot point.

In one form, the pivot point is disposed at a position closer to the engagement means than the actuator along the elongate main body portion. In a preferred form the engagement means is substantially free to move about the pivot point in all directions. In a further form, the engagement means is substantially free to move about the pivot point in an upward and downward direction and from one side direction and to another side direction.

In one form, the pivot point is coupled to a support member that is fixed relative to the ground surface. According to one form, the support member is demountable and/or collapsible and/or easy to transport. In a preferred form, the support member is adapted to be mounted on a vehicle.

In one form, the pivot point is coupled to the support member allowing movement of the device relative to the support member. According to one form, the pivot point is coupled to the support member by means of a flexible elongate member. In a preferred form, the flexible elongate member is a rope, a chain or a metal cable that is strong enough to support the device together with a trunnion roller when engaged on the engagement means.

In one preferred form, the flexible elongate member is coupled to the support member via winching means whereby operation of the winch allows movement of the device in a vertical plane. According to this form, the winching means is operated by means of a winch actuator and in a preferred form, the winch actuator is located on the actuator at one end of the elongate main body portion of the device.

In one form, the engagement means of the device is fixed relative to the elongate main body portion. According to one form, the engagement means includes a forked body portion including two elongate arm portions that are spaced apart at a distance less than the diameter of the trunnion roller. In one form, the two elongate arm portions engage with each of the axle portions of the trunnion roller. In an alternative form, the two elongate arm portions engage with the outer circumferential surface of the trunnion roller. In a preferred form, a strap may be secured around the top of the circumferential surface of the trunnion roller and detachably coupled to one or both of the elongate arm portions to prevent the trunnion roller from disengaging from the device.

In one form, each of the elongate arm portions include at least one flange whereby the flange prevents the trunnion roller from disengaging from the engagement means when the trunnion roller is engaged. In a preferred form, each of the elongate arm portions include at least two flanges respectively, wherein the axle portions, or the outer circumferential edge of the trunnion roller, is positioned between the at least two flanges on the elongate arm portions when the trunnion roller is engaged.

In another form, the elongate arm portions each include an axle receiving recess within which the axle portions of the trunnion roller sit and are prevented from disengaging when the trunnion roller is engaged. In a preferred form, the elongate arm portions further include a hinged closure which moves between an open position and a closed position whereby when in the closed position, the closure prevents the axle portions of the trunnion roller from disengaging from the receiving recess and when in the open position, the axle portions may be removed from the receiving recess.

In one form, the forked body portion protrudes at an angle from the main body portion that facilitates engagement with the axle portions or the outer circumferential edge of the trunnion roller. In a preferred form, the forked body portion protrudes at an angle of about 110° to 160° and from the main body portion and more preferably at an angle of about 115° to 135° and more preferably still. at an angle of about 120° from the main body portion.

According to a further aspect of the present invention, the device is used to assist removal and/or installation of a trunnion roller situated in a mechanical arrangement found in mobile agitator concrete trucks.

According to another aspect the present invention provides a method of replacing a trunnion roller carrying the weight of a mixing bowl on a mobile agitator concrete truck including:
(a) jacking the mixing bowl to a point where the weight of the mixing bowl is no longer resting on the trunnion roller in an operating position;
(b) disengaging the trunnion roller from the operating position wherein the trunnion roller is free to be removed;
(c) engaging the trunnion roller with the engagement means of the device as described above;
(d) operating the device to assist in removing the trunnion roller from the operating position;
(e) disengaging the trunnion roller from the device;
(f) engaging a replacement trunnion roller with the engagement means of the device;
(g) operating the device to assist in positioning the replacement trunnion roller into the operating position and engaging same therein; and,
   releasing the jack whereby the weight of the mixing bowl is resting on the replacement trunnion roller in the operating position.

### BRIEF DESCRIPTION OF THE DRAWINGS

The present invention will become better understood from the following detailed description of preferred but non-limiting embodiments thereof, described in connection with the accompanying drawings, wherein:

FIG. 1 is a schematic diagram of a device in accordance with one embodiment of the present invention;

FIG. 2 is a schematic diagram of a device attached to a support member in accordance with another embodiment engaging a trunnion roller positioned on a mobile concrete agitator truck shown in dashed lines;

FIG. 2A is a schematic diagram of a device in accordance with another embodiment engaging a trunnion roller in the action of positioning the trunnion roller on an axle support;

FIG. 2B is a schematic diagram of an alternative embodiment of the device;

FIG. 2C is a schematic diagram of a further embodiment of the device;

FIG. 2D is a schematic diagram of still a further embodiment of the device;

FIG. 3 is a schematic diagram focusing on the engagement means of the device in a further embodiment;

FIG. 4 is a schematic diagram of a trunnion bearing arrangement on a mobile concrete agitator truck;

FIG. 5 is a schematic diagram of a trunnion bearing arrangement on a mobile agitator truck with the mixing bowl elevated above the trunnion bearings.

FIG. 6 is a schematic diagram of a support member engaged with a mobile agitator truck with a device attached to the support in accordance with a further embodiment, and,

FIG. 7 is a further schematic diagram of device and the support member depicted in FIG. 6 showing further detail.

### DETAILED DESCRIPTION OF THE DRAWINGS

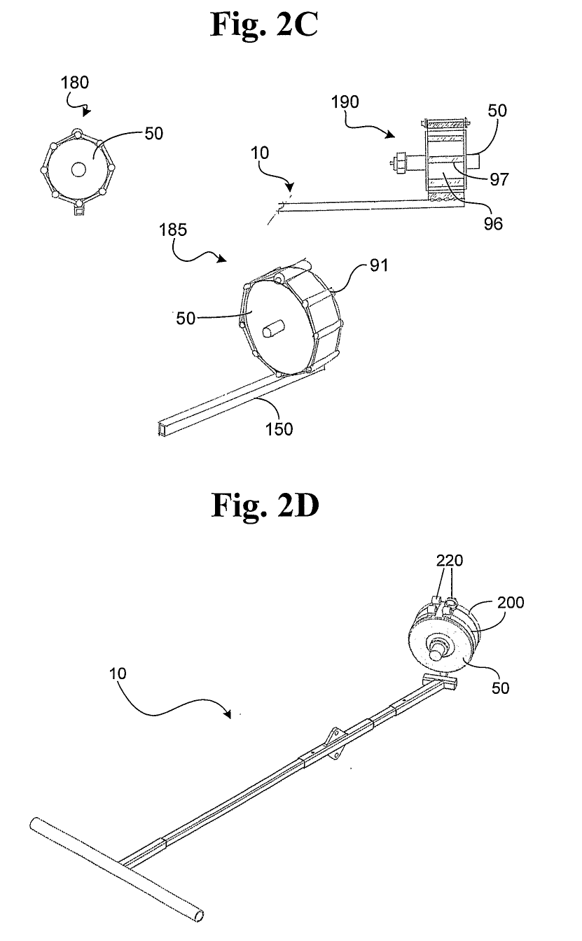

Referring firstly to FIG. 3, there is a depicted a view from above and one side of a trunnion roller 50. As can be seen the trunnion roller includes two axle portions 55 (one of which is not shown) and an outer circumferential portion 60. The outer circumferential portion is rotatable in both directions about the axle portions 55. Trunnion rollers 50 are used to support heavy loads that rotate such as for example a mixing bowl on a mobile concrete agitator truck. In such an arrangement the mixing bowl rests upon the outer circumferential portion 60 and the axle portions are bolted into a fixed U-bracket allowing the outer circumferential portion 60 to rotate relative to the mixing bowl.

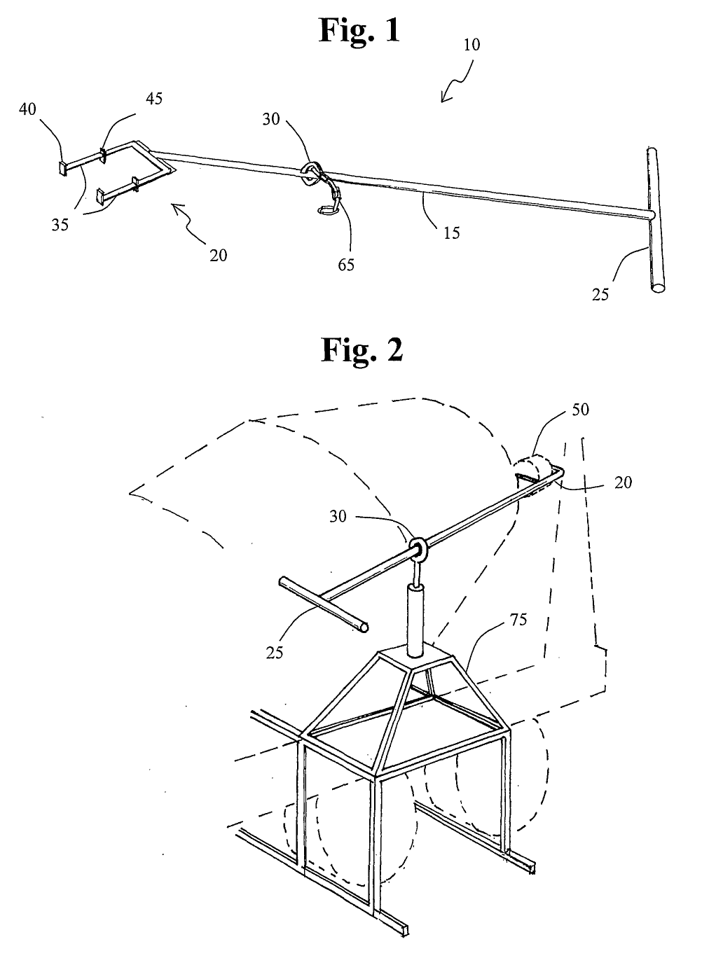

Referring now to FIG. 1, there is shown a device 10 designed to assist in the removal and/or installation of a trunnion roller 50. The device includes a main elongate body portion 15 including an engagement means 20 at one end, and an actuator 25 in the form of a T handle for operating the device 10. At a position along the main body portion 15 there is located a pivot point 30 about which the device 10 pivots when in operation. The pivot point 30 is located closer towards the engagement means 20 than the actuator 25 such that the device 10 can take advantage of the leverage when operated.

The engagement means 20 consists of a forked body portion which includes two elongate arm portions 35 which each include two flanges 40, 45. One flange 40 is located at the end of the elongate arm portions 35 and the other flange 45 located further along. When a trunnion roller 50 is engaged by the engagement means 20 during operation of the device 10, the axle portions 55 of the trunnion roller are located between the flanges 40, 45 of each of the elongate arm portions 35 such that the flanges 40, 45 prevent the trunnion roller 50 from disengaging.

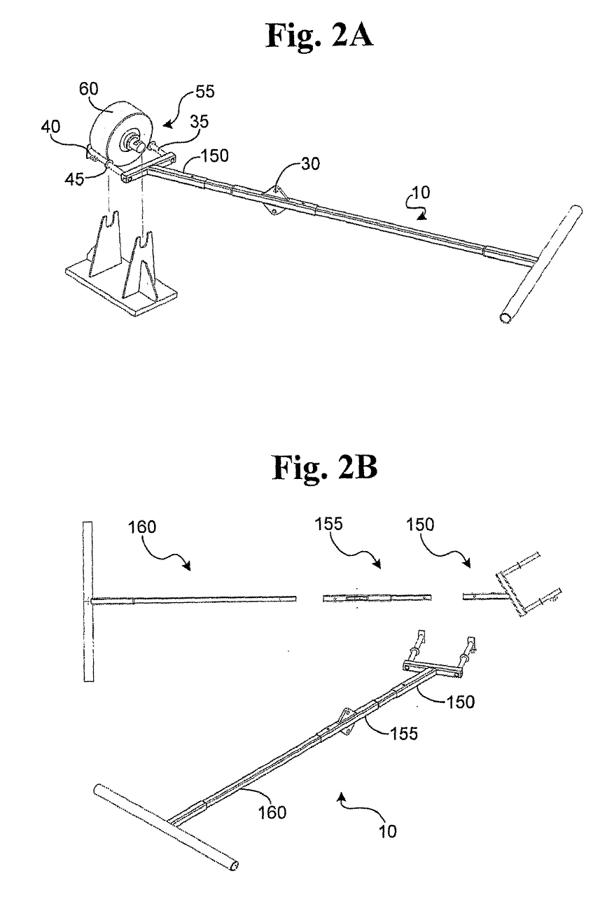

In an alternative arrangement and still referring to FIG. 1, the engagement means 20 engages with the trunnion roller 50 wherein the two elongate arm portions 35 engage with the outer circumferential surface 60 of the trunnion roller 50. This arrangement is further depicted in FIG. 2A where the edge portions of the outer circumferential surface 60 are retained by means of flanges 40 and 45 appearing in the engagement means of the device 10.

Referring now to FIG. 2B, there is shown an alternative embodiment of the device whereby the main body portion includes several body members 150, 155 and 160, allowing the device 10 to collapse down to a size that facilitates the transportation of the device 10 from one site to another in a confined space, say for example in the boot of a car or in a toolbox. Each of the body members 150, 155 and 160 is fitted together by male and female corresponding engagement portions with securing flanges engaging with corresponding holes in the female members. Of course alternative embodiments known by the person skilled in the art for connecting each of the body members 150, 155 and 160 of the device 10 are envisaged within the scope and ambit of the present invention.

Referring now to FIG. 2C, there is shown an alternative embodiment of the engagement portion 91 connected to the device 10. In this figure there are various embodiments 180, 185 and 190 showing the way in which the engagement portion 91 cooperates with the outside circumferential surface 60 of the trunnion roller 50 engaging thereto, such that the trunnion roller 50 may be lifted by means of actuating the device 10 displacing the trunnion roller 50 from its initial position. Referring to 190, there is shown the engagement portion 91 consisting of a long flexible strap 96 with corresponding reinforcement bars 97 along the length of the strap to provide reinforcement to the engagement portion. Typically these reinforcement bars 97 will be made of some type of metal material and/or carbon fibre. At 190, the figure depicts the length of the strap being rolled underneath the circumferential base surface of the trunnion roller 50 whereby the engagement portion 91 is wrapped around the length of the outer circumferential surface 60 of the trunnion roller 60 after which moving to 185 the engagement portion including the attachment 150 is secured to the remaining body portion of the device 10. As can be seen from the end view at 180 the engagement portion engages with the outer circumferential surface 60 of the trunnion roller enabling the device to be lifted and displaced from its initial position by means of actuating the device 10.

Referring now to FIG. 2D, there is shown a further embodiment whereby the engagement portion 200 consists of two substantially circular metal straps that have an attachment point 220 whereby the straps can be secured around the outer circumferential surface of the trunnion roller in a similar arrangement shown in FIG. 2C.

An alternative arrangement of the engagement means is depicted in FIG. 3, wherein the two elongate arm portions 35 include an axle receiving recess 46 within which the axle portions 55 of the trunnion roller 50 sit and are prevented from disengaging when the trunnion roller is engaged. In addition, the elongate arm members further include a closure 47, which is attached to the arm portions 35 via a hinge 48. The hinge 48 allows the closure 47 to move between an open position and a closed position. In the closed position, the closure 47 prevents the axle portions 55 of the trunnion roller 50 from disengaging from the receiving recess 46. When in the open position, the axle portions 55 may be removed from the receiving recess 46.

Referring now to FIG. 1, the pivot point 30 may be attached to a flexible elongate member 65 shown as a chain in this embodiment. The chain 65 may be attached to support member such as a fixed point above where operation of the device 10 is desired. Such a pivot point 30 allows the operation of the device via the actuator 25 whereby the engagement means may be moved about the pivot point in all directions and in particular in an up and down direction as well as from side to side which are most critical in the action of removing and/or installing a trunnion roller from its location.

In an alternative form, FIG. 2 depicts a support member 75 that may be coupled to the device 10 at the pivot point 30. Such a support member 75, which is also quite mobile, allows the device 10 to be operated about its pivoting point 30 at any desired site

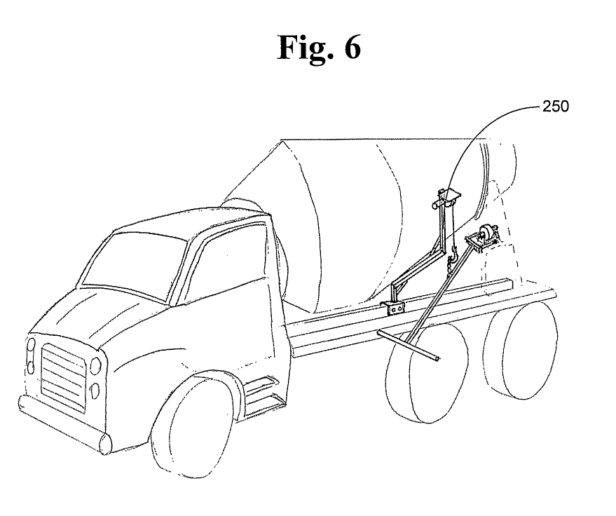

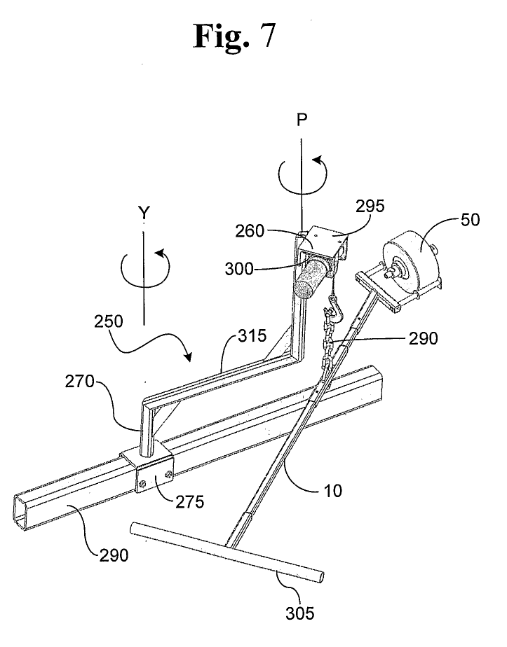

Referring to FIGS. 6 and 7, there is shown a further support member 250 that may be installed on to a vehicle from which the trunnion roller is to be displaced, removed or replaced. The support 250 engages with the body of the vehicle 290 (typically a rail located on the body of large vehicles) via an engagement means 275 in the form of a clamp that may be secured and released via a bolting mechanism.

The support 250 further includes a support structure, made up of a first rotatable portion 270 and a second rotatable portion 260 at a distal end from the engagement portion 275, the first rotatable portion 270 is able to rotate about an axis Y and the second rotatable portion is able to rotate about an axis P. The rotating portions 270 and 260 are then able to assist in the movement and operation of the device 10 which is attached via flexible elongate member 290 to a point 295 at the support member via a winch 300. The support 250 further includes an angled extension region 315 which connects the first rotatable portion 270 and the second rotatable portion 260, the angled extension region 315 is at a sufficient angle to the horizontal and is of sufficient length whereby movement of the device around the first rotatable portion 270, or around the second rotatable portion 260 is not impinged, or inhibited by the large rotatable drum such as typically associated with a mobile agitator concrete truck or vehicle. In effect the angled extension region 315 allows the device 10 to be moved and manipulated around the rotatable drum when removing and/or installing a trunnion roller.

The support member 250 allows the device 10 to be moved, actuated and pivoted around to displace the trunnion roller that may be located on the vehicle and/or insert a replacement trunnion roller correctly in place on a vehicle. The winch 300 attached to the pivot point of the device 10 allows the movement of the device 10 in the vertical plane which further assists in the manipulation of the device 10 to remove and/or replace a trunnion roller from its location. Furthermore, in a preferred form, the winch can be operated to retract or lengthen from the handle or actuator of the device 10 at point 305 providing the operator with complete control of the device from the handle or actuator.

In use, and referring to FIG. 2, the support member 75 allows the device 10 to be set up for operation to assist in the removal or replacement of a trunnion bearing 50 located on a mobile concrete agitator truck (depicted in dashed lines). Once the securing bolts have been removed from a failed trunnion bearing 50 seated in its supporting U-bracket and the mixing bowl has been lifted off the main cylindrical body portion of the trunnion roller, the device 10 may be secured to the support member 75 for operation. By operating the actuator 25, the engagement means 20 may be manipulated to engage the failed trunnion roller 50. Once the trunnion roller is engaged, the actuator may be operated to move the failed trunnion roller 50 to an exterior point where it may be easily removed. A replacement trunnion roller may then be placed on the engagement means 20 and manipulated back into position in the U bracket by operation of the actuator 25. After which the replacement trunnion roller may be secured by securing bolts and the mixing bowl repositioned on the cylindrical body portion 60 of the replacement trunnion roller.

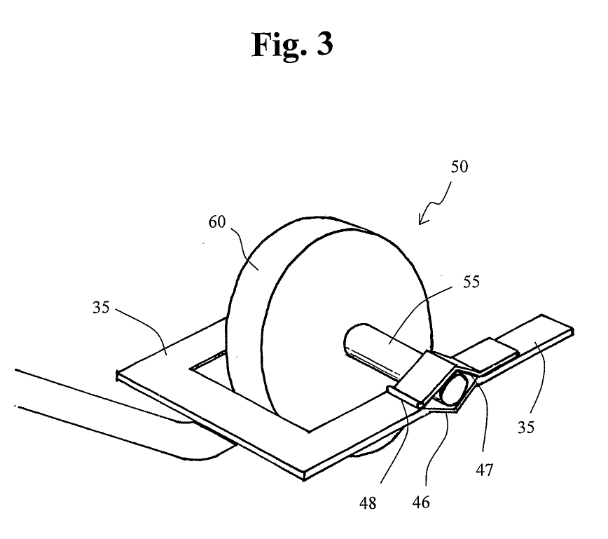

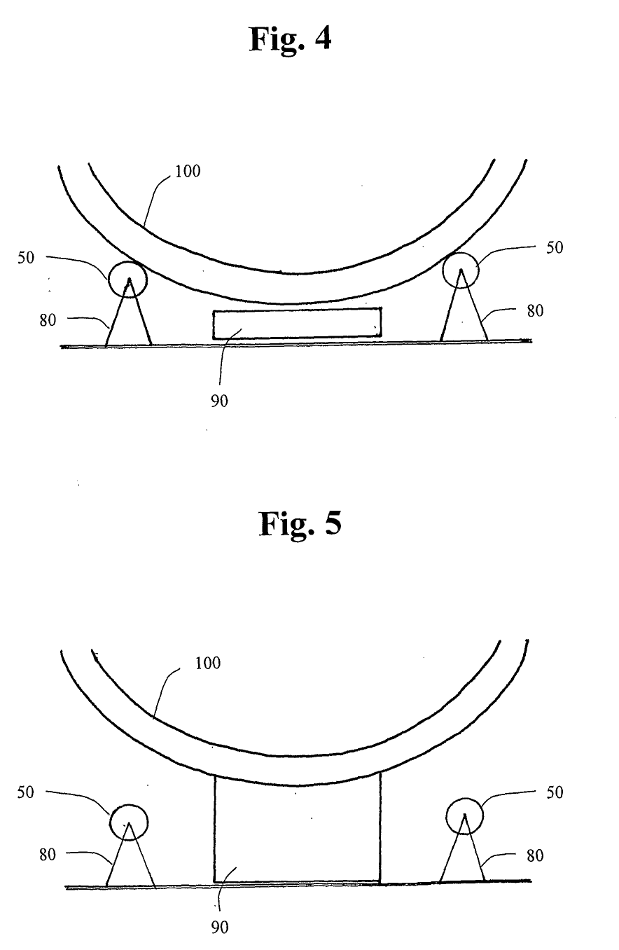

Referring to FIGS. 2, 4 and 5, the following is a description of the steps associated with a method of replacing a failed trunnion roller 50 situated in a mobile concrete agitator truck:
1. Place a purpose built jack 90 beneath the agitator bowl 100 under the bowl ring beam. In this case the jack is inflatable and is driven by compressed air;
2. Commence jacking until the agitator bowl ring beam clears the rollers 50 by a minimum of 150 mm above normal roller height;
3. Loosen and remove restraining nuts from the U bracket 80 containing the failed roller 50;
4. Erect and stabilise the support member 75;
5. Place the device 10 onto the support frame 75 in preparation to remove the failed roller 50;
6. Manipulate the device 10 to remove the failed roller 50;
7. Place the failed roller out of the way of the support member 75;
8. Place a new replacement trunnion roller onto the engagement means 20 of the device 10 and manipulate the new roller into its final position within the U bracket 80;
9. Replace and tighten the restraining nuts to secure the replacement roller into the U-bracket 80;
10. Lower the bowl 100 by releasing the jack 90 and allowing the bowl ring beam to come into contact with the new replaced roller;
11. Remove the jack 90, support member 75 and device 10 and the mobile agitator truck is once again ready to use (ie discharging or mixing of concrete.

This entire operation can be completed on site which removes the need to hire cranes and allows use of concrete that may have otherwise gone to waste.

Finally, it can be understood that the inventive concept in any of its aspects can be incorporated in many different constructions so that generality of the preceding description is not superseded by the particularity of the attached drawings. Various alterations, modifications and/or additions may be incorporated into the various constructions and arrangements of parts without departing from the spirit or ambit of the present invention.

1. A device for assisting removal and/or installation of a trunnion roller, the device including:
an elongate main body portion including an actuator at one end and an engagement at the other end for engaging and retaining a trunnion roller;
a pivot point disposed at a position along the elongate main body portion between the actuator and the engagement, wherein operation of the actuator causes the engagement to move about the pivot point.

2. A device according to claim 1 wherein the pivot point is disposed at a position closer to the engagement than the actuator along the elongate main body portion.

3. A device according to claim 1 wherein the engagement is substantially free to move about the pivot point in all directions.

4. A device according to claim 1 wherein the engagement is substantially free to move about the pivot point an upward and downward direction and from one side direction and to another side direction.

5. A device according to claim 1 wherein the pivot point is coupled to a support member that is fixed relative to the ground surface.

6. A device according to claim 5 wherein the support member is demountable and/or collapsible and/or easy to transport.

7. A device according to claim 5 wherein the support member is adapted to be mounted on a vehicle.

8. A device according to claim 5 wherein the pivot point is coupled to the support member allowing movement of the device relative to the support member.

9. A device according to claim 8 wherein the pivot point is coupled to the support member using a flexible elongate member.

10. A device according to claim 9 wherein the flexible elongate member is a rope, a chain or a metal cable.

11. A device according to claim 9 wherein the flexible elongate member is coupled to the support member via a winch such that operation of the winch allows movement of the device in a vertical plane.

12. A device according to claim 11 wherein the winch is operated using a winch actuator, wherein the winch actuator is located on the actuator at one end of the elongate main body portion of the device.

13. A device according to claim 1 wherein the engagement of the device is fixed relative to the elongate main body portion.

14. A device according to claim 1 wherein the engagement includes a forked body portion including two elongate arm portions that are spaced apart at a distance less than the diameter of the trunnion roller.

15. A device according to claim 14 wherein the two elongate arm portions engage with each of the axel portions of the trunnion roller.

16. A device according to claim 14 wherein the two elongate arm portions engage with the outer circumferential surface of the trunnion roller.

17. A device according to claim 16 wherein a strap is capable of being secured around the top of the circumferential surface of the trunnion roller and detachably coupled to one or both of the elongate arm portions to prevent the trunnion roller from disengaging from the device.

18. A device according to claim 14 wherein each of the elongate arm portions include at least one flange whereby the flange prevents the trunnion roller from disengaging from the engagement when the trunnion roller is engaged.

19. A device according to claim 14 wherein each of the elongate arm portions include at least two flanges respectively, wherein the axel portions, or the outer circumferential edge of the trunnion roller, is positioned between the at least two flanges on the elongate arm portions when the trunnion roller is engaged.

20. A device according to claim 14 wherein the elongate arm portions each include an axel receiving recess within which the axel portions of the trunnion roller sit and are prevented from disengaging when the trunnion roller is engaged.

21. A device according to claim 20 wherein the elongate arm portions further include a hinged closure which moves between an open position and a closed position whereby when in the closed position, the closure prevents the axel portions of the trunnion roller from disengaging from the receiving recess and when in the open position, the axel portions are capable of being removed from the receiving recess.

22. A device according to claim 14 wherein the forked body portion protrudes at an angle from the main body portion that facilitates engagement with the axel portions or the outer circumferential edge of the trunnion roller.

23. A device according to claim 22 wherein the forked body portion protrudes at an angle of about 110° to 160° and from the main body portion.

24. A device according to claim 1 wherein the device is configured to be used to assist removal and/or installation of a trunnion roller situated in a mechanical arrangement found in mobile agitator concrete trucks.

25. A method of replacing a trunnion roller carrying the weight of a mixing bowl on a mobile agitator concrete truck including:
jacking the mixing bowl to a point where the weight of the mixing bowl is no longer resting on the trunnion roller in an operating position;
disengaging the trunnion roller from the operating position wherein the trunnion roller is free to be removed;
engaging the trunnion roller with an engagement of a device including:
an elongate main body portion including an actuator at one end and an engagement at the other end for engaging and retaining a trunnion roller; and
a pivot point disposed at a position along the elongate main body portion between the actuator and the engagement, wherein operation of the actuator causes the engagement to move about the pivot point,
operating the device to assist in removing the trunnion roller from the operating position;
disengaging the trunnion roller from the device;
engaging a replacement trunnion roller with the engagement of the device;
operating the device to assist in positioning the replacement trunnion roller into the operating position and engaging same therein; and,
releasing the jack whereby the weight of the mixing bowl is resting on the replacement trunnion roller in the operating position.

26. A support member for use with a device including an elongate main body portion including an actuator at one end and an engagement at the other end for engaging and retaining a trunnion roller, and a pivot point disposed at a position along the elongate main body portion between the actuator and the engagement, wherein operation of the actuator causes the engagement to move about the pivot point; the support member including:
a main body portion coupled to an engagement at one end, the engagement adapted to engage with and fix the support member to a portion of a vehicle, wherein the main body portion is rotatable in a substantially vertical axis relative to the engagement;
an attachment at the other end of the main body portion, the attachment capable of releaseably attaching to the pivot point of the device.

27. A support member according to claim 26 wherein the attachment is rotatable in a substantially vertical axis relative to the main body portion.

28. A support member according to claim 26 wherein the attachment is attached to the pivot point via a winch.
